(19) United States
(12) Patent Application Publication
(10) Pub. No.: US 2024/0223690 A1
(43) Pub. Date: Jul. 4, 2024

(54) COMMUNICATION DEVICE HAVING A BLUETOOTH CONTROLLER DEVICE

(71) Applicant: REXON TECHNOLOGY CO., LTD., Taichung (TW)

(72) Inventors: Chun-Wei CHEN, Taichung (TW); Chien-Li MA, Taichung (TW); Shih-Chi FENG, Taichung (TW)

(21) Appl. No.: 18/542,467

(22) Filed: Dec. 15, 2023

(30) Foreign Application Priority Data
Jan. 4, 2023 (TW) 112200066

(51) Int. Cl. H04M 1/72412; H04M 1/72409

(52) U.S. Cl. CPC H04M 1/72412; H04M 1/724094; H04M 2250/02; H04R 1/10; H04R 2420/07

(57) ABSTRACT

A communication device includes a Bluetooth earphone device, a Bluetooth controller device and a walkie-talkie device. The Bluetooth earphone device includes an earphone body, and a first Bluetooth transceiver configured to transmit and receive voice signals. The Bluetooth controller device includes a controller operation button, and a first Bluetooth Low Energy transceiver configured to transmit a controller talk signal when the controller operation button is triggered. The walkie-talkie device includes a walkie-talkie body configured to transmit and receive wireless communication signals, a second Bluetooth transceiver and a second Bluetooth Low Energy transceiver. When the walkie-talkie body receives the controller talk signal from the first Bluetooth Low Energy transceiver through the second Bluetooth Low Energy transceiver, the walkie-talkie body receives the voice signal transmitted by the first Bluetooth transceiver through the second Bluetooth transceiver, and transmits the wireless communication signal corresponding to the voice signal thus received.

### CROSS-REFERENCE TO RELATED APPLICATION

This application claims priority to Taiwanese Utility Model Patent Application No. 112200066, filed on Jan. 4, 2023, and incorporated by reference herein in its entirety.

### FIELD

The disclosure relates to a communication device, and more particularly to a communication device having a Bluetooth controller device.

### BACKGROUND

All elements of a conventional walkie-talkie are integrated together in a handset configuration. When a user wants to communicate over the conventional walkie-talkie, the user has to hold up the conventional walkie-talkie to his/her face by his/her hand and press a push-to-talk (PTT) button of the conventional walkie-talkie. Therefore, the conventional walkie-talkie is less convenient for the user to use because of its handset configuration.

### SUMMARY

Therefore, an object of the disclosure is to provide a communication device having a Bluetooth controller device. The communication device can alleviate at least one of the drawbacks of the prior art.

According to the disclosure, the communication device includes a Bluetooth earphone device, a Bluetooth controller device and a walkie-talkie device. The Bluetooth earphone device includes an earphone body and a first Bluetooth transceiver. The earphone body is configured to capture and play back sounds. The first Bluetooth transceiver is connected to the earphone body, and is configured to transmit and receive voice signals that correspond to the sounds using Bluetooth technology. The Bluetooth controller device includes a controller operation button and a first Bluetooth Low Energy transceiver. The first Bluetooth Low Energy transceiver is connected to the controller operation button, and is configured to transmit a controller talk signal using Bluetooth Low Energy technology when the controller operation button is triggered. The walkie-talkie device includes a walkie-talkie body, a second Bluetooth transceiver and a second Bluetooth Low Energy transceiver. The walkie-talkie body is configured to transmit and receive wireless communication signals. The second Bluetooth transceiver is connected to the walkie-talkie body. The second Bluetooth Low Energy transceiver is connected to the walkie-talkie body. When the walkie-talkie body receives the controller talk signal from the first Bluetooth Low Energy transceiver through the second Bluetooth Low Energy transceiver, the walkie-talkie body receives the voice signal that is transmitted by the first Bluetooth transceiver through the second Bluetooth transceiver, and transmits the wireless communication signal that corresponds to the voice signal thus received.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating an embodiment of a communication device according to the disclosure applied to a user and a bicycle.

FIG. 2 is a schematic view illustrating installation of a walkie-talkie device and a Bluetooth controller device of the embodiment on the bicycle.

FIG. 3 is a perspective view illustrating the Bluetooth controller device of the embodiment.

FIG. 4 is a block diagram illustrating the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

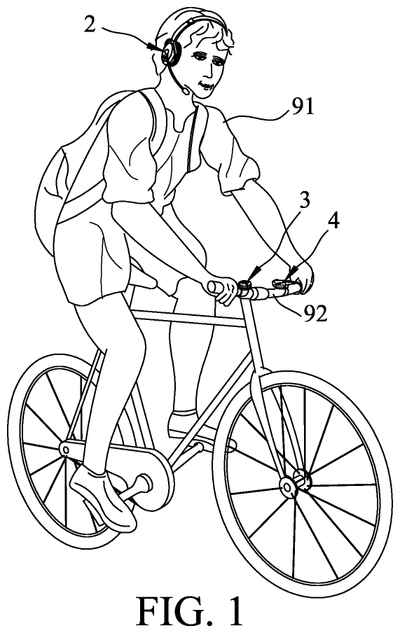

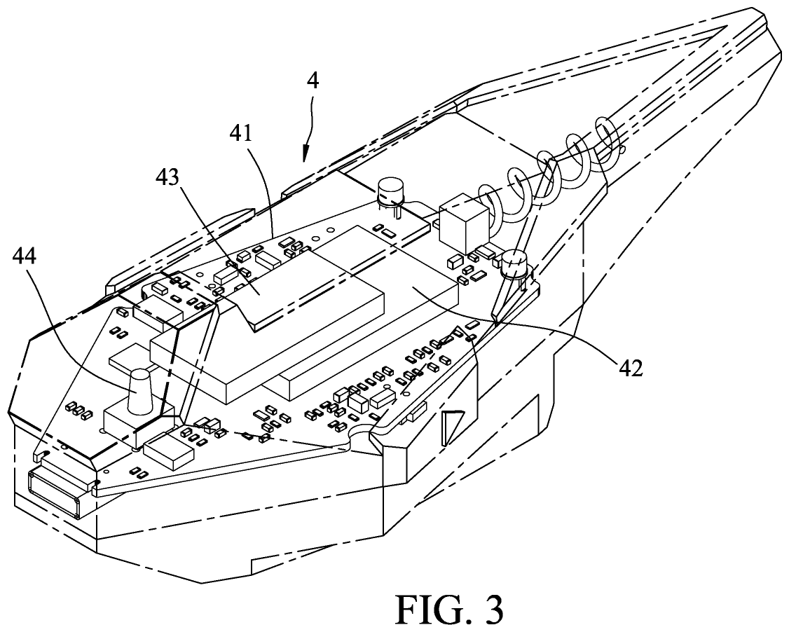

Referring to FIGS. 1, 2 and 3, an embodiment of a communication device according to the disclosure is applied to a user 91 and a bicycle 92, and includes a Bluetooth earphone device 2, a Bluetooth controller device 3 and a walkie-talkie device 4. In this embodiment, the Bluetooth earphone device 2 is worn by the user 91, and the Bluetooth controller device 3 and the walkie-talkie device 4 are disposed on the bicycle 92.

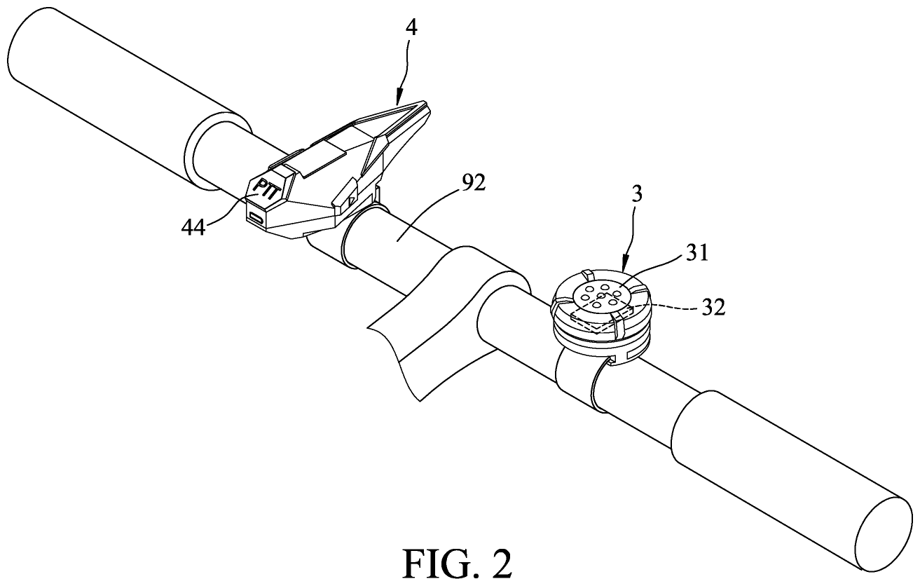

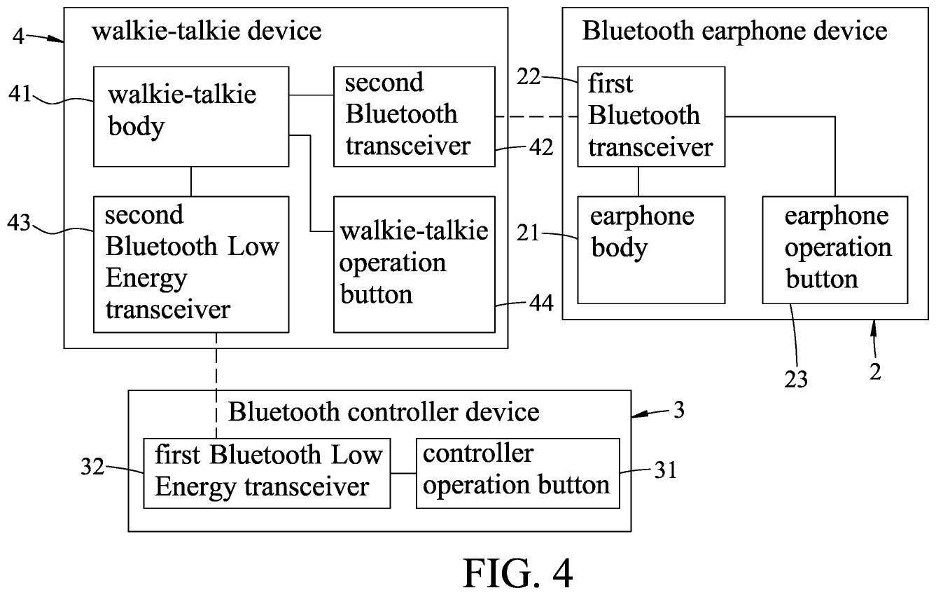

Referring to FIGS. 2, 3 and 4, the Bluetooth earphone device 2 includes an earphone body 21, a first Bluetooth transceiver 22 and an earphone operation button 23. The earphone body 21 is configured to capture and play back sounds. The first Bluetooth transceiver 22 is connected to the earphone body 21 and the earphone operation button 23, is configured to transmit and receive voice signals that correspond to the sounds using Bluetooth technology, and is further configured to transmit an earphone talk signal using Bluetooth technology when the earphone operation button 23 is triggered.

The Bluetooth controller device 3 includes a controller operation button 31 and a first Bluetooth Low Energy transceiver 32. The first Bluetooth Low Energy transceiver 32 is connected to the controller operation button 31, and is configured to transmit a controller talk signal using Bluetooth Low Energy technology when the controller operation button 31 is triggered. In this embodiment, the Bluetooth controller device 3 can be disposed on the bicycle 92, or can be carried in a hand of the user 91 after being removed from the bicycle 92.

The walkie-talkie device 4 includes a walkie-talkie body 41, a second Bluetooth transceiver 42, a second Bluetooth Low Energy transceiver 43 and a walkie-talkie operation button 44. The walkie-talkie body 41 is connected to the second Bluetooth transceiver 42, the second Bluetooth Low Energy transceiver 43 and the walkie-talkie operation button 44, and is configured to transmit and receive wireless communication signals.

In this embodiment, each of the first Bluetooth transceiver 22 and the second Bluetooth transceiver 42 complies with classic Bluetooth protocol, and each of the first Bluetooth Low Energy transceiver 32 and the second Bluetooth Low Energy transceiver 43 complies with Bluetooth Low Energy protocol. The classic Bluetooth protocol and the Bluetooth Low Energy protocol are known in the art, and details thereof are omitted herein for the sake of brevity.

When the walkie-talkie body 41 receives a wireless communication signal from another communication device, the walkie-talkie body 41 transmits a voice signal corresponding to the wireless communication signal to the earphone body 21 through the second Bluetooth transceiver 42 and the first Bluetooth transceiver 22, and the earphone body 21 plays back a sound corresponding to the voice signal.

When the user 91 (see FIG. 1) wants to communicate over the communication device of this embodiment, there are three ways available for the user 91 (see FIG. 1).

The first way is for the user 91 (see FIG. 1) to trigger the controller operation button 31 and speak. When the controller operation button 31 is triggered, the first Bluetooth Low Energy transceiver 32 transmits a controller talk signal to the walkie-talkie body 41 through the second Bluetooth Low Energy transceiver 43. When the walkie-talkie body 41 receives the controller talk signal from the first Bluetooth Low Energy transceiver 32 through the second Bluetooth Low Energy transceiver 43, the walkie-talkie body 41 causes the earphone body 21 to capture sound so as to generate a voice signal corresponding to the sound through the second Bluetooth transceiver 42 and the first Bluetooth transceiver 22, receives the voice signal from the earphone body 21 through the second Bluetooth transceiver 42 and the first Bluetooth transceiver 22, and transmits a wireless communication signal corresponding to the voice signal thus received to another communication device.

The second way is for the user 91 (see FIG. 1) to trigger the earphone operation button 23 and speak. When the earphone operation button 23 is triggered, the first Bluetooth transceiver 22 transmits an earphone talk signal to the walkie-talkie body 41 through the second Bluetooth transceiver 42. When the walkie-talkie body 41 receives the earphone talk signal from the first Bluetooth transceiver 22 through the second Bluetooth transceiver 42, the walkie-talkie body 41 causes the earphone body 21 to capture sound so as to generate a voice signal corresponding to the sound through the second Bluetooth transceiver 42 and the first Bluetooth transceiver 22, receives the voice signal from the earphone body 21 through the second Bluetooth transceiver 42 and the first Bluetooth transceiver 22, and transmits a wireless communication signal corresponding to the voice signal thus received to another communication device.

The third way is for the user 91 (see FIG. 1) to trigger the walkie-talkie operation button 44 and speak. When the walkie-talkie operation button 44 is triggered, the walkie-talkie body 41 causes the earphone body 21 to capture sound so as to generate a voice signal corresponding to the sound through the second Bluetooth transceiver 42 and the first Bluetooth transceiver 22, receives the voice signal from the earphone body 21 through the second Bluetooth transceiver 42 and the first Bluetooth transceiver 22, and transmits a wireless communication signal corresponding to the voice signal thus received to another communication device.

Referring to FIGS. 1, 2 and 4, as such, when the user 91 is near the bicycle 92, the user 91 can selectively trigger one of the controller operation button 31, the earphone operation button 23 and the walkie-talkie operation button 44 according to the current situation and speak, so as to have his/her voice transmitted. For example, when the user 91 is away from the walkie-talkie device 4, the user 91 can hold the Bluetooth controller device 3 and trigger the controller operation button 31, or trigger the earphone operation button 23; however, when the user 91 is proximate to the walkie-talkie device 4, the user 91 can trigger the walkie-talkie operation button 44. Since the Bluetooth earphone device 2 can capture and play back sounds, it is not necessary for the user 91 to hold up the walkie-talkie device 42 to his/her face, so the convenience of using the communication device of this embodiment can be greatly improved. When the user 91 rides the bicycle 92, it is also very convenient for the user 91 to use the communication device of this embodiment.

In view of the above, by virtue of the Bluetooth earphone device 2, the Bluetooth controller device 3 and the walkie-talkie device 4, the user 91 can selectively trigger one of the controller operation button 31, the earphone operation button 23 and the walkie-talkie operation button 44 so as to have his/her voice transmitted, thereby improving the convenience of using the communication device of this embodiment.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A communication device comprising:
a Bluetooth earphone device including
an earphone body configured to capture and play back sounds, and
a first Bluetooth transceiver connected to said earphone body, and configured to transmit and receive voice signals that correspond to the sounds using Bluetooth technology;
a Bluetooth controller device including
a controller operation button, and
a first Bluetooth Low Energy transceiver connected to said controller operation button, and configured to transmit a controller talk signal using Bluetooth Low Energy technology when said controller operation button is triggered; and
a walkie-talkie device including
a walkie-talkie body configured to transmit and receive wireless communication signals,
a second Bluetooth transceiver connected to said walkie-talkie body, and
a second Bluetooth Low Energy transceiver connected to said walkie-talkie body;
when said walkie-talkie body receives the controller talk signal from said first Bluetooth Low Energy transceiver through said second Bluetooth Low Energy transceiver, said walkie-talkie body receiving the voice signal that is transmitted by said first Bluetooth transceiver through said second Bluetooth transceiver, and transmitting the wireless communication signal that corresponds to the voice signal thus received.

2. The communication device as claimed in claim 1, wherein:
said Bluetooth earphone device further includes an earphone operation button that is connected to said first Bluetooth transceiver;
said first Bluetooth transceiver is further configured to transmit an earphone talk signal using Bluetooth technology when said earphone operation button is triggered; and
when said walkie-talkie body receives the earphone talk signal from said first Bluetooth transceiver through said second Bluetooth transceiver, said walkie-talkie body receives the voice signal that is transmitted by said first Bluetooth transceiver through said second Bluetooth transceiver, and transmits the wireless communication signal that corresponds to the voice signal thus received.

3. The communication device as claimed in claim 2, wherein:
said walkie-talkie device further includes a walkie-talkie operation button that is connected to said walkie-talkie body; and
when said walkie-talkie operation button is triggered, said walkie-talkie body receives the voice signal that is transmitted by said first Bluetooth transceiver through said second Bluetooth transceiver, and transmits the wireless communication signal that corresponds to the voice signal thus received.
